(19) United States
(12) Patent Application Publication
(10) Pub. No.: US 2019/0042434 A1
(43) Pub. Date: Feb. 7, 2019

(54) DYNAMIC PREFETCHER TUNING

(71) Applicants: Corey D. Gough, Portland, OR (US); Mihir Patel, Hillsboro, OR (US); Ryan Kern, Hillsboro, OR (US); Dilip Shivaraju, Hillsboro, OR (US); Emad Attia, Calgary (CA)

(72) Inventors: Corey D. Gough, Portland, OR (US); Mihir Patel, Hillsboro, OR (US); Ryan Kern, Hillsboro, OR (US); Dilip Shivaraju, Hillsboro, OR (US); Emad Attia, Calgary (CA)

(21) Appl. No.: 15/839,515

(22) Filed: Dec. 12, 2017

(51) Int. Cl. G06F 12/0862

(52) U.S. Cl. CPC G06F 12/0862; G06F 2212/602; G06F 2212/1041; G06F 2212/1021

(57) ABSTRACT

There is disclosed in one example a server apparatus for use in a data center, including: a processor having a memory prefetcher; a memory; a memory bus to communicatively couple the processor to the memory; and a dynamic prefetcher tuning agent (DPTA) including a memory bandwidth utilization module (MBUM) configured to: determine that the prefetcher is enabled; determine that memory bandwidth utilization of the memory bus exceeds a first threshold; and disable the prefetcher.

### FIELD OF THE SPECIFICATION

This disclosure relates in general to the field of network computing, and more particularly, though not exclusively, to a system and method for dynamic prefetcher tuning.

### BACKGROUND

In some modern data centers, the function of a device or appliance may not be tied to a specific, fixed hardware configuration. Rather, processing, memory, storage, and accelerator functions may in some cases be aggregated from different locations to form a virtual “composite node.” A contemporary network may include a data center hosting a large number of generic hardware server devices, contained in a server rack for example, and controlled by a hypervisor. Each hardware device may run one or more instances of a virtual device, such as a workload server or virtual desktop.

### BRIEF DESCRIPTION OF THE DRAWINGS

The present disclosure is best understood from the following detailed description when read with the accompanying figures. It is emphasized that, in accordance with the standard practice in the industry, various features are not necessarily drawn to scale, and are used for illustration purposes only. Where a scale is shown, explicitly or implicitly, it provides only one illustrative example. In other embodiments, the dimensions of the various features may be arbitrarily increased or reduced for clarity of discussion.

FIG. 1 is a block diagram of selected components of a data center with network connectivity, according to one or more examples of the present specification.

FIG. 2 is a block diagram of selected components of an end-user computing device, according to one or more examples of the present specification.

FIG. 3 is a block diagram of components of a computing platform, according to one or more examples of the present specification.

FIG. 4 is a block diagram of a central processing unit (CPU), according to one or more examples of the present specification.

FIG. 5 is a block diagram of a hardware platform, according to one or more examples of the present specification.

FIG. 6 is a block diagram of a processor that may have more than one core, may have an integrated memory controller, and may have integrated graphics, according to one or more examples of the present specification.

FIG. 7 is a block diagram of a system, according to one or more examples of the present specification.

FIG. 8 is a block diagram of a server device, according to one or more examples of the present specification.

FIG. 9 is a block diagram of a method performed, for example, at boot time to set prefetcher thresholds, according to one or more examples of the present specification.

FIG. 10 is a flowchart of a further method, according to one or more examples of the present specification.

### EMBODIMENTS OF THE DISCLOSURE

The following disclosure provides many different embodiments, or examples, for implementing different features of the present disclosure. Specific examples of components and arrangements are described below to simplify the present disclosure. These are, of course, merely examples and are not intended to be limiting. Further, the present disclosure may repeat reference numerals and/or letters in the various examples. This repetition is for the purpose of simplicity and clarity and does not in itself dictate a relationship between the various embodiments and/or configurations discussed. Different embodiments may have different advantages, and no particular advantage is necessarily required of any embodiment.

A contemporary computing platform, such as a hardware platform provided by Intel® or similar, may include a capability for monitoring device performance and making decisions about resource provisioning. For example, in a large data center such as may be provided by a cloud service provider (CSP), the hardware platform may include rackmounted servers with compute resources such as processors, memory, storage pools, accelerators, and other similar resources. As used herein, “cloud computing” includes network-connected computing resources and technology that enables ubiquitous (often worldwide) access to data, resources, and/or technology. Cloud resources are generally characterized by great flexibility to dynamically assign resources according to current workloads and needs. This can be accomplished, for example, via virtualization, wherein resources such as hardware, storage, and networks are provided to a virtual machine (VM) via a software abstraction layer, and/or containerization, wherein instances of network functions are provided in “containers” that are separated from one another, but that share underlying operating system, memory, and driver resources.

In a traditional native computing environment, wherein the operator of a server or a network appliance owns and operates the physical hardware and runs either customized or preinstalled software on the device, the hardware platform may be configured according to the application or class of applications that run on the server. The operator knows the characteristics of the workload, and can determine whether to enable options like Turbo, hyperthreading, Enhanced Intel® Speedstep Technology (EIST), sub-nonuniform memory access (NUMA), clustering, snoop modes, or similar. The operator can determine the optimal mix of power and performance for the enterprise computing environment.

However, in cloud environments, the hardware platform may not be directly owned or operated by the end user or operator. Rather, the hardware platform may be provided as a subscription service, such as in a platform as a service (PAAS) wherein the hardware platform is owned by a cloud service provider operating a large data center. In in these large data centers, often entire racks or groups of racks are provisioned with identical or nearly identical hardware, and a number of tenants are allocated resources such as processing cores, memory, storage, network bandwidth, storage bandwidth, and similar on a subscription basis. In this cloud environment, the operational options discussed previously may be set only opportunistically. The operator may not have the ability to change some or any of these options at run time, and it may be inefficient for the cloud service provider to manually configure different devices for the workloads. Furthermore, as discussed above, different workloads may be provided on the same device, so that in some cases optimizations for a first workload may collide with optimizations for a second workload. Furthermore, the types of applications running on a given specific server hardware platform may change over time.

This is the case, for example, with prefetchers. Very specific classes of applications see a substantial performance increase from enabling prefetchers, notably high performance computing (HPC) applications. These applications access memory with a high degree of spatial locality, and thus greatly benefit from having memory prefetched into the cache where it can be accessed immediately without imposing wait states on the processor. On the other hand, for apps with more random memory access requirements (such as common web or email servers), the use of a prefetcher by other applications can actually put a strain on the memory bandwidth. For these more random workloads, the prefetcher provides at best minimal performance improvement, and at worst a penalty if memory bandwidth is already constrained. Consider, for example, a case in which a hardware platform has 20 available cores, along with some available bandwidth of local memory. The hardware platform includes a prefetcher that can either be turned on or off. In many cases, the prefetcher is a global prefetcher that is either on for all workloads on the server, or off for all workloads on the server. Consider also that on the server there may be workloads running according to three different tenants. Tenant 1 may be running a load balanced web server application serving a common web page on fifteen of the 25 available cores. Tenant 2 may be providing a load balanced e-mail server on six of the available cores. Tenant 3 may be using only four of the 25 cores, but is running a massively parallel large matrix computation, such as a ray tracing program or similar, on those four cores.

With the prefetcher turned on, the four cores running the massively parallel computation benefit significantly from the prefetcher because their memory accesses are highly structured, sequential, and predictable. Thus, the prefetcher can consistently prefetch the necessary data for the massively parallel operation, and keep the caches for those four cores relatively full. In the meantime, the other 21 cores operating on the server see a substantial hit to their own memory performance. The relatively small number of four cores running the massively parallel operation effectively monopolize the memory bandwidth because the prefetcher is busy keeping their caches full.

This can lead to a situation where the first and second tenants operating the web servers and email servers are highly dissatisfied with the service, while the tenant operating the third workload is highly satisfied.

For the part of the CSP, it needs to meet customer service level agreements, but also wants to provide a consistent level of performance. Existing systems can make it very difficult to provide a consistent performance in a multitenant environment such as a public cloud where a “noisy neighbor” (e.g., the small number of cores running a massively parallel computation) is able to consume a disproportionate amount of resources like memory bandwidth, thus starving out other tenants.

For example, in a common workload such as a front end web server, prefetching is of little benefit. If a large number of web servers are deployed in VMs on a single cloud server, the resulting application activity and ineffectual prefetching could exhaust available memory bandwidth. Thus, disabling prefetchers would relieve stress on the system's overall memory bandwidth and provide a more consistent performance experience to tenants. Indeed, this may be more appropriate for a cloud application or a cloud platform, because workloads such as web servers, e-mail servers, and their associated virtualized network functions (VNFs) are much more common in the cloud environment than massively parallel computations that may benefit from prefetchers, which may be more suitable for HPC deployments. Nevertheless, the CSP may not have direct control over the workload that tenants run on their allocated resources in the cloud environment. Thus, there is danger that a single noisy neighbor can exhaust a critical resource such as memory bandwidth.

In existing systems, mechanisms are available for allocating resources such as CPU count, cycles, I/O rates (disk and network), and total memory capacity. The Intel® resource director technology (RDT) provides monitoring of memory bandwidth, while also providing both monitoring and allocation of cache. But RDT has relatively limited adoption within many cloud environments, and requires software to enable a hypervisor to take advantage of the RDT features, such as resource monitoring identifier (RMID) tracking and calculating acceptable rate limits. Furthermore, there is a limit on the number of RMIDs available, which may prevent tracking of all tenants, especially in private cloud environments where over-subscription is common. Thus, it is desirable to provide a software transparent solution for achieving the result of effectively throttling a noisy neighbor with low implementation overhead, and without the need for additional software configuration.

Dynamic prefetcher tuning according to the present specification detects if system memory bandwidth limits have been reached, and upon detecting this event, disables prefetchers globally on the server to reduce pressure on resources such as memory. In the previous example, when the noisy neighbor massively parallel tenant begins consuming an inordinate amount of memory bandwidth by use of the prefetcher, a memory bandwidth utilization module (MBUM) may measure the total consumption of memory bandwidth on the platform. Note that the MBUM need not measure the bandwidth consumed by each tenant (and, indeed, may not have visibility into which tenants are using how much memory bandwidth), but rather measures overall memory bandwidth consumption of the system. If the MBUM determines that the consumption has exceeded a threshold (such as a certain percentage of the theoretical maximum memory bandwidth) then the MBUM may throttle the memory bandwidth by turning off the prefetcher. This means that the noisy neighbor will consume less memory bandwidth, and the desired result of providing a more uniform quality of service to all tenants is achieved.

The theoretical maximum memory bandwidth may be computed by a memory bandwidth computation module, and may be calculated for example as a function of several values available through registers or model-specific registers (MSRs), including DRAM speed, memory channel population, channel interleaving settings, and uncore frequency. Using this theoretical maximum, a threshold for acceptable memory bandwidth consumption can be determined, and prefetching may be enabled only so long as overall memory bandwidth consumption remains below that threshold. Once prefetching has been disabled, a second threshold may be defined, wherein prefetching is not re-enabled until memory bandwidth utilization falls below the second threshold. The use of two different thresholds can help prevent a “thrashing” situation, wherein the prefetcher is continuously enabled and disabled as bandwidth utilization hovers around the first threshold.

The dynamic prefetcher tuning of the present specification provides for dynamic adjustment of the use of the hardware prefetcher to balance maximum performance with performance variability based on available memory bandwidth. This provides system administrators the ability to take full advantage of hardware prefetchers under ideal operating conditions, while preserving memory bandwidth to provide more consistent performance under heavy utilization periods. In one embodiment, the behavior of the dynamic prefetcher tuning system may be set in the basic input/output system (BIOS) via exposed threshold values provided as percentage of maximum bandwidth. For example, a user interface may be provided in the BIOS settings wherein the user can select a first threshold and a second threshold, and wherein useful default values may be provided. This enables a system administrator to optimize the prefetcher settings for the tenant applications running on systems in times of both light and heavy utilization, with no manual monitoring or intervention required by the administrator during runtime.

As utilization on each socket rises and falls, the memory bandwidth utilization module, which may be provided in firmware, monitors resource consumption and adjusts prefetcher usage accordingly. In one example, dedicated performance monitoring units (PMUs) within the CPU memory controller may be used to measure bandwidth utilization. When memory bandwidth exceeds the maximum prefetching threshold, on a socket wherein this feature is enabled, the prefetcher is disabled and the value of MSR 0x1A4 (i.e., for certain Intel® processor families) can be ignored. This avoids the problem of creating additional writes to the existing prefetcher control MSRs, while providing the desired prefetcher disabling option to reduce memory bandwidth consumption. Note that in some embodiments, there may be multiple registers to control prefetchers, and addresses other than 0x1A4 may be used.

In proof of concept implementations of the above described system, wherein performance is measured for a web-based transactional workload run in several scenarios, substantial results were realized by the use of dynamic prefetcher tuning. In a test case, several web servers for the workload were run as tenants on a single system. Two new tenants were added running a memory intensive HPC workload on the same hardware platform, and average web server throughput dramatically dropped by approximately 9%. When the prefetcher was disabled to conserve system memory bandwidth, the web server throughput increased again by approximately 8%. Thus, even with the HPC workload running on the hardware platform, the performance hit to the web servers was only approximately 1%.

Note that currently existing Intel® RDT technologies are capable of limiting I/O, such as for disk and network, and software solutions exist to limit hardware threads, cycles, and memory dedicated to applications or virtual machines (VMs). However, the dynamic prefetcher tuning of the present specification governs memory bandwidth directly. Other systems such as RDT may be used to monitor this resource, but have a limited number of RMIDs, and may require extensive operating system changes to govern the resource. Thus, the dynamic prefetcher tuning system of the present specification provides for governing of the prefetcher state beneath the operating system level, with the flexibility to change, enable, or disable thresholds based on expected application or tenant behavior.

A system and method for dynamic prefetcher tuning will now be described with more particular reference to the attached FIGURES. It should be noted that throughout the FIGURES, certain reference numerals may be repeated to indicate that a particular device or block is wholly or substantially consistent across the FIGURES. This is not, however, intended to imply any particular relationship between the various embodiments disclosed. In certain examples, a genus of elements may be referred to by a particular reference numeral (“widget 10”), while individual species or examples of the genus may be referred to by a hyphenated numeral (“first specific widget 10-1” and “second specific widget 10-2”).

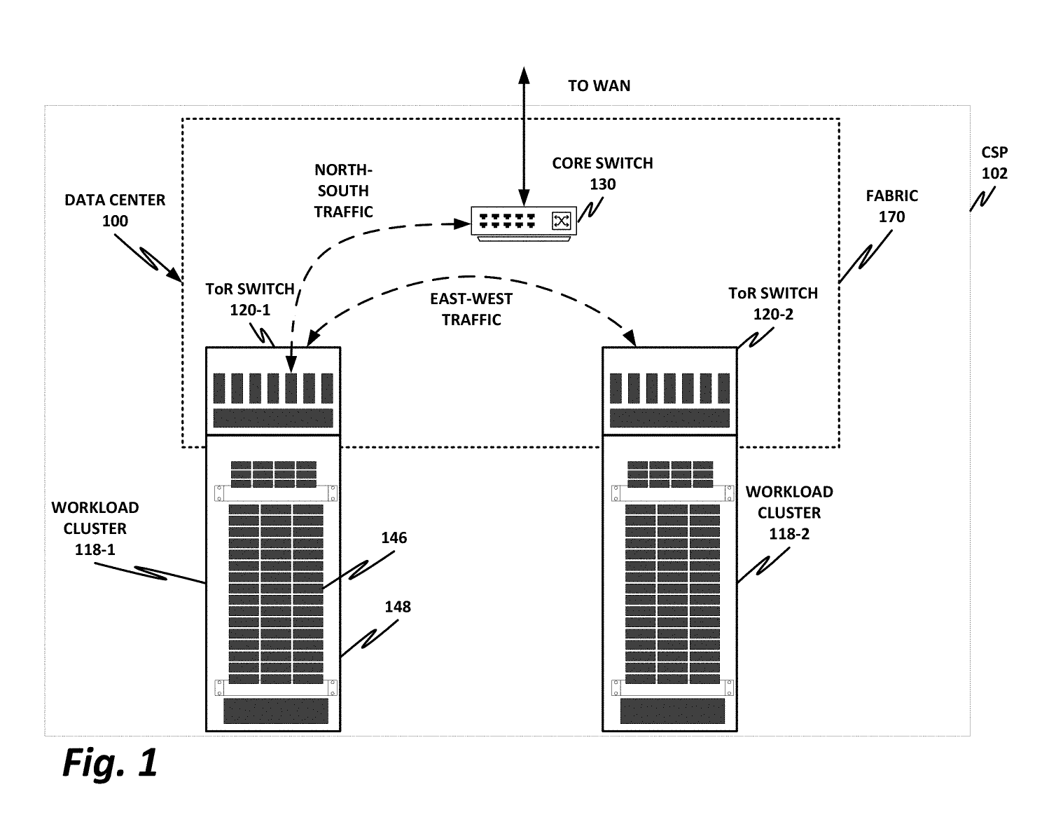

FIG. 1 is a block diagram of selected components of a data center with connectivity to network 100 of a cloud service provider (CSP) 102, according to one or more examples of the present specification. The disclosed architecture of FIG. 1 may be provided in some embodiments with the dynamic prefetcher tuning of the present specification, and may benefit therefrom. CSP 102 may be, by way of nonlimiting example, a traditional enterprise data center, an enterprise “private cloud,” or a “public cloud,” providing services such as infrastructure as a service (IaaS), platform as a service (PaaS), or software as a service (SaaS).

CSP 102 may provision some number of workload clusters 118, which may be clusters of individual servers, blade servers, rackmount servers, or any other suitable server topology. In this illustrative example, two workload clusters, 118-1 and 118-2 are shown, each providing rackmount servers 146 in a chassis 148.

In this illustration, workload clusters 118 are shown as modular workload clusters conforming to the rack unit (“U”) standard, in which a standard rack, 19 inches wide, may be built to accommodate 42 units (42U), each 1.75 inches high and approximately 36 inches deep. In this case, compute resources such as processors, memory, storage, accelerators, and switches may fit into some multiple of rack units from one to 42.

Each server 146 may host a standalone operating system and provide a server function, or servers may be virtualized, in which case they may be under the control of a virtual machine manager (VMM), hypervisor, and/or orchestrator, and may host one or more virtual machines, virtual servers, or virtual appliances. These server racks may be collocated in a single data center, or may be located in different geographic data centers. Depending on the contractual agreements, some servers 146 may be specifically dedicated to certain enterprise clients or tenants, while others may be shared.

The various devices in a data center may be connected to each other via a switching fabric 170, which may include one or more high speed routing and/or switching devices. Switching fabric 170 may provide both “north-south” traffic (e.g., traffic to and from the wide area network (WAN), such as the internet), and “east-west” traffic (e.g., traffic across the data center). Historically, north-south traffic accounted for the bulk of network traffic, but as web services become more complex and distributed, the volume of east-west traffic has risen. In many data centers, east-west traffic now accounts for the majority of traffic.

Furthermore, as the capability of each server 146 increases, traffic volume may further increase. For example, each server 146 may provide multiple processor slots, with each slot accommodating a processor having four to eight cores, along with sufficient memory for the cores. Thus, each server may host a number of VMs, each generating its own traffic.

To accommodate the large volume of traffic in a data center, a highly capable switching fabric 170 may be provided. Switching fabric 170 is illustrated in this example as a “flat” network, wherein each server 146 may have a direct connection to a top-of-rack (ToR) switch 120 (e.g., a “star” configuration), and each ToR switch 120 may couple to a core switch 130. This two-tier flat network architecture is shown only as an illustrative example. In other examples, other architectures may be used, such as three-tier star or leaf-spine (also called “fat tree” topologies) based on the “Clos” architecture, hub-and-spoke topologies, mesh topologies, ring topologies, or 3-D mesh topologies, by way of nonlimiting example.

The fabric itself may be provided by any suitable interconnect. For example, each server 146 may include an Intel® Host Fabric Interface (HFI), a network interface card (NIC), or other host interface. The host interface itself may couple to one or more processors via an interconnect or bus, such as PCI, PCIe, or similar, and in some cases, this interconnect bus may be considered to be part of fabric 170.

The interconnect technology may be provided by a single interconnect or a hybrid interconnect, such as where PCIe provides on-chip communication, 1 Gb or 10 Gb copper Ethernet provides relatively short connections to a ToR switch 120, and optical cabling provides relatively longer connections to core switch 130. Interconnect technologies include, by way of nonlimiting example, Intel® Omni-Path™, TrueScale™, Ultra Path Interconnect (UPI) (formerly called QPI or KTI), FibreChannel, Ethernet, FibreChannel over Ethernet (FCoE), InfiniBand, PCI, PCIe, or fiber optics, to name just a few. Some of these will be more suitable for certain deployments or functions than others, and selecting an appropriate fabric for the instant application is an exercise of ordinary skill.

Note however that while high-end fabrics such as Omni-Path™ are provided herein by way of illustration, more generally, fabric 170 may be any suitable interconnect or bus for the particular application. This could, in some cases, include legacy interconnects like local area networks (LANs), token ring networks, synchronous optical networks (SONET), asynchronous transfer mode (ATM) networks, wireless networks such as WiFi and Bluetooth, “plain old telephone system” (POTS) interconnects, or similar. It is also expressly anticipated that in the future, new network technologies will arise to supplement or replace some of those listed here, and any such future network topologies and technologies can be or form a part of fabric 170.

In certain embodiments, fabric 170 may provide communication services on various “layers,” as originally outlined in the OSI seven-layer network model. In contemporary practice, the OSI model is not followed strictly. In general terms, layers 1 and 2 are often called the “Ethernet” layer (though in large data centers, Ethernet has often been supplanted by newer technologies). Layers 3 and 4 are often referred to as the transmission control protocol/internet protocol (TCP/IP) layer (which may be further subdivided into TCP and IP layers). Layers 5-7 may be referred to as the “application layer.” These layer definitions are disclosed as a useful framework, but are intended to be nonlimiting.

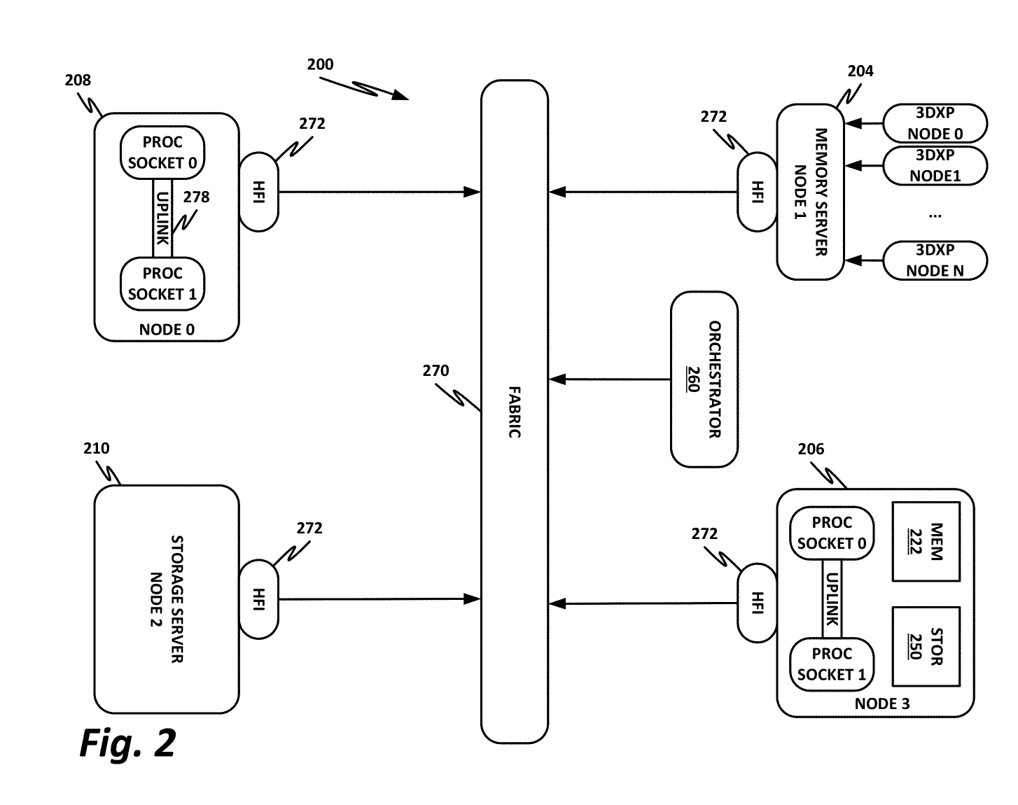

FIG. 2 is a block diagram of an end-user computing device 200, according to one or more examples of the present specification. The disclosed architecture of FIG. 2 may be provided in some embodiments with the dynamic prefetcher tuning of the present specification, and may benefit therefrom.

In this example, a fabric 270 is provided to interconnect various aspects of computing device 200. Fabric 270 may be the same as fabric 170 of FIG. 1, or may be a different fabric. As above, fabric 270 may be provided by any suitable interconnect technology. In this example, Intel® Omni-Path™ is used as an illustrative and nonlimiting example.

As illustrated, computing device 200 includes a number of logic elements forming a plurality of nodes. It should be understood that each node may be provided by a physical server, a group of servers, or other hardware. Each server may be running one or more virtual machines as appropriate to its application.

Node 0 208 is a processing node including a processor socket 0 and processor socket 1. The processors may be, for example, Intel® Xeon™ processors with a plurality of cores, such as 4 or 8 cores. Node 0 208 may be configured to provide network or workload functions, such as by hosting a plurality of virtual machines or virtual appliances.

Onboard communication between processor socket 0 and processor socket 1 may be provided by an onboard uplink 278. This may provide a very high speed, short-length interconnect between the two processor sockets, so that virtual machines running on node 0 208 can communicate with one another at very high speeds. To facilitate this communication, a virtual switch (vSwitch) may be provisioned on node 0 208, which may be considered to be part of fabric 270.

Node 0 208 connects to fabric 270 via an HFI 272. HFI 272 may connect to an Intel® Omni-Path™ fabric. In some examples, communication with fabric 270 may be tunneled, such as by providing UPI tunneling over Omni-Path™.

Because computing device 200 may provide many functions in a distributed fashion that in previous generations were provided onboard, a highly capable HFI 272 may be provided. HFI 272 may operate at speeds of multiple gigabits per second, and in some cases may be tightly coupled with node 0 208. For example, in some embodiments, the logic for HFI 272 is integrated directly with the processors on a system-on-a-chip. This provides very high speed communication between HFI 272 and the processor sockets, without the need for intermediary bus devices, which may introduce additional latency into the fabric. However, this is not to imply that embodiments where HFI 272 is provided over a traditional bus are to be excluded. Rather, it is expressly anticipated that in some examples, HFI 272 may be provided on a bus, such as a PCIe bus, which is a serialized version of PCI that provides higher speeds than traditional PCI. Throughout computing device 200, various nodes may provide different types of HFIs 272, such as onboard HFIs and plug-in HFIs. It should also be noted that certain blocks in a system on a chip may be provided as intellectual property (IP) blocks that can be “dropped” into an integrated circuit as a modular unit. Thus, HFI 272 may in some cases be derived from such an IP block.

Note that in “the network is the device” fashion, node 0 208 may provide limited or no onboard memory or storage. Rather, node 0 208 may rely primarily on distributed services, such as a memory server and a networked storage server. Onboard, node 0 208 may provide only sufficient memory and storage to bootstrap the device and get it communicating with fabric 270. This kind of distributed architecture is possible because of the very high speeds of contemporary data centers, and may be advantageous because there is no need to over-provision resources for each node. Rather, a large pool of high-speed or specialized memory may be dynamically provisioned between a number of nodes, so that each node has access to a large pool of resources, but those resources do not sit idle when that particular node does not need them.

In this example, a node 1 memory server 204 and a node 2 storage server 210 provide the operational memory and storage capabilities of node 0 208. For example, memory server node 1 204 may provide remote direct memory access (RDMA), whereby node 0 208 may access memory resources on node 1 204 via fabric 270 in a DMA fashion, similar to how it would access its own onboard memory. The memory provided by memory server 204 may be traditional memory, such as double data rate type 3 (DDR3) dynamic random access memory (DRAM), which is volatile, or may be a more exotic type of memory, such as a persistent fast memory (PFM) like Intel® 3D Crosspoint™ (3DXP), which operates at DRAM-like speeds, but is nonvolatile.

Similarly, rather than providing an onboard hard disk for node 0 208, a storage server node 2 210 may be provided. Storage server 210 may provide a networked bunch of disks (NBOD), PFM, redundant array of independent disks (RAID), redundant array of independent nodes (RAIN), network attached storage (NAS), optical storage, tape drives, or other nonvolatile memory solutions.

Thus, in performing its designated function, node 0 208 may access memory from memory server 204 and store results on storage provided by storage server 210. Each of these devices couples to fabric 270 via a HFI 272, which provides fast communication that makes these technologies possible.

By way of further illustration, node 3 206 is also depicted. Node 3 206 also includes a HFI 272, along with two processor sockets internally connected by an uplink. However, unlike node 0 208, node 3 206 includes its own onboard memory 222 and storage 250. Thus, node 3 206 may be configured to perform its functions primarily onboard, and may not be required to rely upon memory server 204 and storage server 210. However, in appropriate circumstances, node 3 206 may supplement its own onboard memory 222 and storage 250 with distributed resources similar to node 0 208.

The basic building block of the various components disclosed herein may be referred to as “logic elements.” Logic elements may include hardware (including, for example, a software-programmable processor, an ASIC, or an FPGA), external hardware (digital, analog, or mixed-signal), software, reciprocating software, services, drivers, interfaces, components, modules, algorithms, sensors, components, firmware, microcode, programmable logic, or objects that can coordinate to achieve a logical operation. Furthermore, some logic elements are provided by a tangible, non-transitory computer-readable medium having stored thereon executable instructions for instructing a processor to perform a certain task. Such a non-transitory medium could include, for example, a hard disk, solid state memory or disk, read-only memory (ROM), persistent fast memory (PFM) (e.g., Intel® 3D Crosspoint™), external storage, redundant array of independent disks (RAID), redundant array of independent nodes (RAIN), network-attached storage (NAS), optical storage, tape drive, backup system, cloud storage, or any combination of the foregoing by way of nonlimiting example. Such a medium could also include instructions programmed into an FPGA, or encoded in hardware on an ASIC or processor.

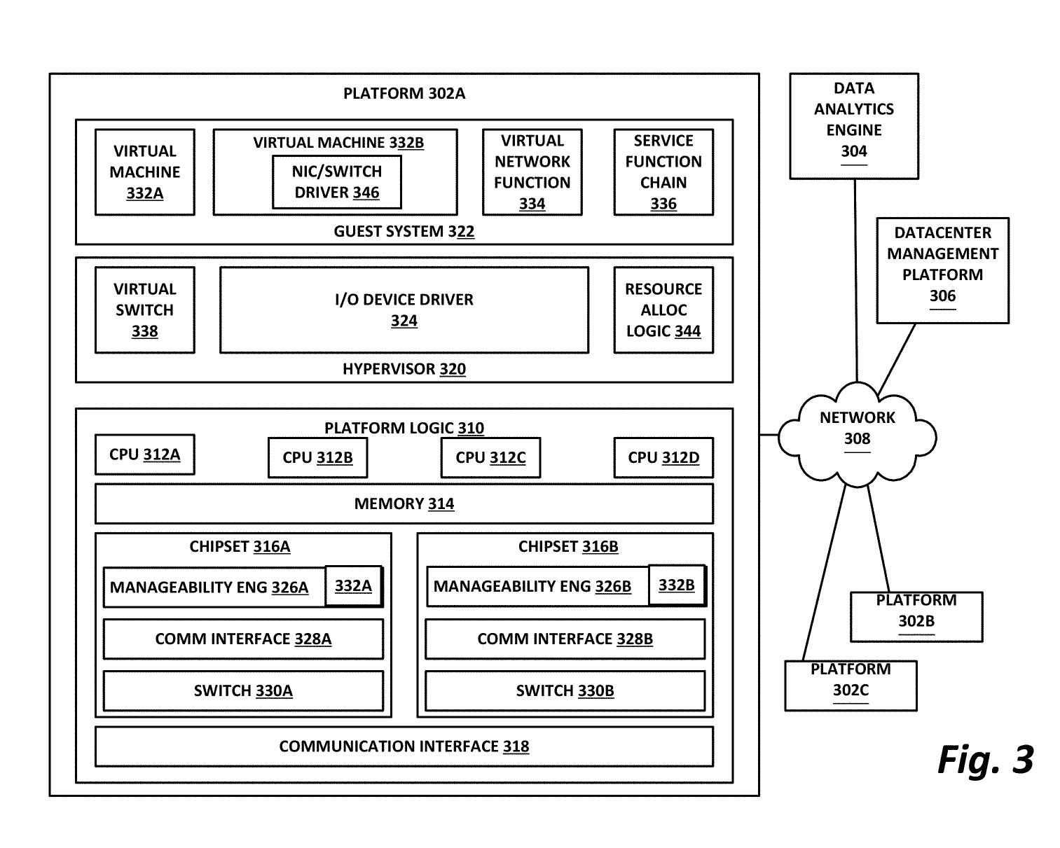

FIG. 3 illustrates a block diagram of components of a computing platform 302A, according to one or more examples of the present specification. The disclosed architecture of FIG. 3 may be provided in some embodiments with the dynamic prefetcher tuning of the present specification, and may benefit therefrom. In the embodiment depicted, platforms 302A, 302B, and 302C, along with a data center management platform 306 and data analytics engine 304 are interconnected via network 308. In other embodiments, a computer system may include any suitable number of (i.e., one or more) platforms. In some embodiments (e.g., when a computer system only includes a single platform), all or a portion of the system management platform 306 may be included on a platform 302. A platform 302 may include platform logic 310 with one or more central processing units (CPUs) 312, memories 314 (which may include any number of different modules), chipsets 316, communication interfaces 318, and any other suitable hardware and/or software to execute a hypervisor 320 or other operating system capable of executing workloads associated with applications running on platform 302. In some embodiments, a platform 302 may function as a host platform for one or more guest systems 322 that invoke these applications. Platform 302A may represent any suitable computing environment, such as a high performance computing environment, a data center, a communications service provider infrastructure (e.g., one or more portions of an Evolved Packet Core), an in-memory computing environment, a computing system of a vehicle (e.g., an automobile or airplane), an Internet of Things environment, an industrial control system, other computing environment, or combination thereof.

In various embodiments of the present disclosure, accumulated stress and/or rates of stress accumulated of a plurality of hardware resources (e.g., cores and uncores) are monitored and entities (e.g., system management platform 306, hypervisor 320, or other operating system) of computer platform 302A may assign hardware resources of platform logic 310 to perform workloads in accordance with the stress information. In some embodiments, self-diagnostic capabilities may be combined with the stress monitoring to more accurately determine the health of the hardware resources. Each platform 302 may include platform logic 310. Platform logic 310 comprises, among other logic enabling the functionality of platform 302, one or more CPUs 312, memory 314, one or more chipsets 316, and communication interfaces 328. Although three platforms are illustrated, computer platform 302A may be interconnected with any suitable number of platforms. In various embodiments, a platform 302 may reside on a circuit board that is installed in a chassis, rack, or other suitable structure that comprises multiple platforms coupled together through network 308 (which may comprise, e.g., a rack or backplane switch).

CPUs 312 may each comprise any suitable number of processor cores and supporting logic (e.g., uncores). The cores may be coupled to each other, to memory 314, to at least one chipset 316, and/or to a communication interface 318, through one or more controllers residing on CPU 312 and/or chipset 316. In particular embodiments, a CPU 312 is embodied within a socket that is permanently or removably coupled to platform 302A. Although four CPUs are shown, a platform 302 may include any suitable number of CPUs.

Memory 314 may comprise any form of volatile or nonvolatile memory including, without limitation, magnetic media (e.g., one or more tape drives), optical media, random access memory (RAM), read-only memory (ROM), flash memory, removable media, or any other suitable local or remote memory component or components. Memory 314 may be used for short, medium, and/or long term storage by platform 302A. Memory 314 may store any suitable data or information utilized by platform logic 310, including software embedded in a computer readable medium, and/or encoded logic incorporated in hardware or otherwise stored (e.g., firmware). Memory 314 may store data that is used by cores of CPUs 312. In some embodiments, memory 314 may also comprise storage for instructions that may be executed by the cores of CPUs 312 or other processing elements (e.g., logic resident on chipsets 316) to provide functionality associated with the manageability engine 326 or other components of platform logic 310. A platform 302 may also include one or more chipsets 316 comprising any suitable logic to support the operation of the CPUs 312. In various embodiments, chipset 316 may reside on the same die or package as a CPU 312 or on one or more different dies or packages. Each chipset may support any suitable number of CPUs 312. A chipset 316 may also include one or more controllers to couple other components of platform logic 310 (e.g., communication interface 318 or memory 314) to one or more CPUs. In the embodiment depicted, each chipset 316 also includes a manageability engine 326. Manageability engine 326 may include any suitable logic to support the operation of chipset 316. In a particular embodiment, a manageability engine 326 (which may also be referred to as an innovation engine) is capable of collecting real-time telemetry data from the chipset 316, the CPU(s) 312 and/or memory 314 managed by the chipset 316, other components of platform logic 310, and/or various connections between components of platform logic 310. In various embodiments, the telemetry data collected includes the stress information described herein.

In various embodiments, a manageability engine 326 operates as an out-of-band asynchronous compute agent which is capable of interfacing with the various elements of platform logic 310 to collect telemetry data with no or minimal disruption to running processes on CPUs 312. For example, manageability engine 326 may comprise a dedicated processing element (e.g., a processor, controller, or other logic) on chipset 316, which provides the functionality of manageability engine 326 (e.g., by executing software instructions), thus conserving processing cycles of CPUs 312 for operations associated with the workloads performed by the platform logic 310. Moreover the dedicated logic for the manageability engine 326 may operate asynchronously with respect to the CPUs 312 and may gather at least some of the telemetry data without increasing the load on the CPUs.

A manageability engine 326 may process telemetry data it collects (specific examples of the processing of stress information will be provided herein). In various embodiments, manageability engine 326 reports the data it collects and/or the results of its processing to other elements in the computer system, such as one or more hypervisors 320 or other operating systems and/or system management software (which may run on any suitable logic such as system management platform 306). In particular embodiments, a critical event such as a core that has accumulated an excessive amount of stress may be reported prior to the normal interval for reporting telemetry data (e.g., a notification may be sent immediately upon detection).

Additionally, manageability engine 326 may include programmable code configurable to set which CPU(s) 312 a particular chipset 316 will manage and/or which telemetry data will be collected.

Chipsets 316 also each include a communication interface 328. Communication interface 328 may be used for the communication of signaling and/or data between chipset 316 and one or more I/O devices, one or more networks 308, and/or one or more devices coupled to network 308 (e.g., system management platform 306). For example, communication interface 328 may be used to send and receive network traffic such as data packets. In a particular embodiment, a communication interface 328 comprises one or more physical network interface controllers (NICs), also known as network interface cards or network adapters. A NIC may include electronic circuitry to communicate using any suitable physical layer and data link layer standard such as Ethernet (e.g., as defined by a IEEE 802.3 standard), Fibre Channel, InfiniBand, Wi-Fi, or other suitable standard. A NIC may include one or more physical ports that may couple to a cable (e.g., an Ethernet cable). A NIC may enable communication between any suitable element of chipset 316 (e.g., manageability engine 326 or switch 330) and another device coupled to network 308. In various embodiments a NIC may be integrated with the chipset (i.e., may be on the same integrated circuit or circuit board as the rest of the chipset logic) or may be on a different integrated circuit or circuit board that is electromechanically coupled to the chipset.

In particular embodiments, communication interfaces 328 may allow communication of data (e.g., between the manageability engine 326 and the data center management platform 306) associated with management and monitoring functions performed by manageability engine 326. In various embodiments, manageability engine 326 may utilize elements (e.g., one or more NICs) of communication interfaces 328 to report the telemetry data (e.g., to system management platform 306) in order to reserve usage of NICs of communication interface 318 for operations associated with workloads performed by platform logic 310.

Switches 330 may couple to various ports (e.g., provided by NICs) of communication interface 328 and may switch data between these ports and various components of chipset 316 (e.g., one or more Peripheral Component Interconnect Express (PCIe) lanes coupled to CPUs 312). Switches 330 may be a physical or virtual (i.e., software) switch.

Platform logic 310 may include an additional communication interface 318. Similar to communication interfaces 328, communication interfaces 318 may be used for the communication of signaling and/or data between platform logic 310 and one or more networks 308 and one or more devices coupled to the network 308. For example, communication interface 318 may be used to send and receive network traffic such as data packets. In a particular embodiment, communication interfaces 318 comprise one or more physical NICs. These NICs may enable communication between any suitable element of platform logic 310 (e.g., CPUs 312 or memory 314) and another device coupled to network 308 (e.g., elements of other platforms or remote computing devices coupled to network 308 through one or more networks).

Platform logic 310 may receive and perform any suitable types of workloads. A workload may include any request to utilize one or more resources of platform logic 310, such as one or more cores or associated logic. For example, a workload may comprise a request to instantiate a software component, such as an I/O device driver 324 or guest system 322; a request to process a network packet received from a virtual machine 332 or device external to platform 302A (such as a network node coupled to network 308); a request to execute a process or thread associated with a guest system 322, an application running on platform 302A, a hypervisor 320 or other operating system running on platform 302A; or other suitable processing request.

A virtual machine 332 may emulate a computer system with its own dedicated hardware. A virtual machine 332 may run a guest operating system on top of the hypervisor 320. The components of platform logic 310 (e.g., CPUs 312, memory 314, chipset 316, and communication interface 318) may be virtualized such that it appears to the guest operating system that the virtual machine 332 has its own dedicated components.

A virtual machine 332 may include a virtualized NIC (vNIC), which is used by the virtual machine as its network interface. A vNIC may be assigned a media access control (MAC) address or other identifier, thus allowing multiple virtual machines 332 to be individually addressable in a network.

VNF 334 may comprise a software implementation of a functional building block with defined interfaces and behavior that can be deployed in a virtualized infrastructure. In particular embodiments, a VNF 334 may include one or more virtual machines 332 that collectively provide specific functionalities (e.g., wide area network (WAN) optimization, virtual private network (VPN) termination, firewall operations, load-balancing operations, security functions, etc.). A VNF 334 running on platform logic 310 may provide the same functionality as traditional network components implemented through dedicated hardware. For example, a VNF 334 may include components to perform any suitable NFV workloads, such as virtualized evolved packet core (vEPC) components, mobility management entities, 3rd Generation Partnership Project (3GPP) control and data plane components, etc.

SFC 336 is a group of VNFs 334 organized as a chain to perform a series of operations, such as network packet processing operations. Service function chaining may provide the ability to define an ordered list of network services (e.g. firewalls, load balancers) that are stitched together in the network to create a service chain.

A hypervisor 320 (also known as a virtual machine monitor) may comprise logic to create and run guest systems 322. The hypervisor 320 may present guest operating systems run by virtual machines with a virtual operating platform (i.e., it appears to the virtual machines that they are running on separate physical nodes when they are actually consolidated onto a single hardware platform) and manage the execution of the guest operating systems by platform logic 310. Services of hypervisor 320 may be provided by virtualizing in software or through hardware assisted resources that require minimal software intervention, or both. Multiple instances of a variety of guest operating systems may be managed by the hypervisor 320. Each platform 302 may have a separate instantiation of a hypervisor 320.

Hypervisor 320 may be a native or bare-metal hypervisor that runs directly on platform logic 310 to control the platform logic and manage the guest operating systems. Alternatively, hypervisor 320 may be a hosted hypervisor that runs on a host operating system and abstracts the guest operating systems from the host operating system. Hypervisor 320 may include a virtual switch 338 that may provide virtual switching and/or routing functions to virtual machines of guest systems 322. The virtual switch 338 may comprise a logical switching fabric that couples the vNICs of the virtual machines 332 to each other, thus creating a virtual network through which virtual machines may communicate with each other.

Virtual switch 338 may comprise a software element that is executed using components of platform logic 310. In various embodiments, hypervisor 320 may be in communication with any suitable entity (e.g., a SDN controller) which may cause hypervisor 320 to reconfigure the parameters of virtual switch 338 in response to changing conditions in platform 302 (e.g., the addition or deletion of virtual machines 332 or identification of optimizations that may be made to enhance performance of the platform).

Hypervisor 320 may also include resource allocation logic 344, which may include logic for determining allocation of platform resources based on the telemetry data (which may include stress information). Resource allocation logic 344 may also include logic for communicating with various components of platform logic 310 entities of platform 302A to implement such optimization, such as components of platform logic 310.

Any suitable logic may make one or more of these optimization decisions. For example, system management platform 306; resource allocation logic 344 of hypervisor 320 or other operating system; or other logic of computer platform 302A may be capable of making such decisions. In various embodiments, the system management platform 306 may receive telemetry data from and manage workload placement across multiple platforms 302. The system management platform 306 may communicate with hypervisors 320 (e.g., in an out-of-band manner) or other operating systems of the various platforms 302 to implement workload placements directed by the system management platform.

The elements of platform logic 310 may be coupled together in any suitable manner. For example, a bus may couple any of the components together. A bus may include any known interconnect, such as a multi-drop bus, a mesh interconnect, a ring interconnect, a point-to-point interconnect, a serial interconnect, a parallel bus, a coherent (e.g. cache coherent) bus, a layered protocol architecture, a differential bus, or a Gunning transceiver logic (GTL) bus.

Elements of the computer platform 302A may be coupled together in any suitable manner such as through one or more networks 308. A network 308 may be any suitable network or combination of one or more networks operating using one or more suitable networking protocols. A network may represent a series of nodes, points, and interconnected communication paths for receiving and transmitting packets of information that propagate through a communication system. For example, a network may include one or more firewalls, routers, switches, security appliances, antivirus servers, or other useful network devices.

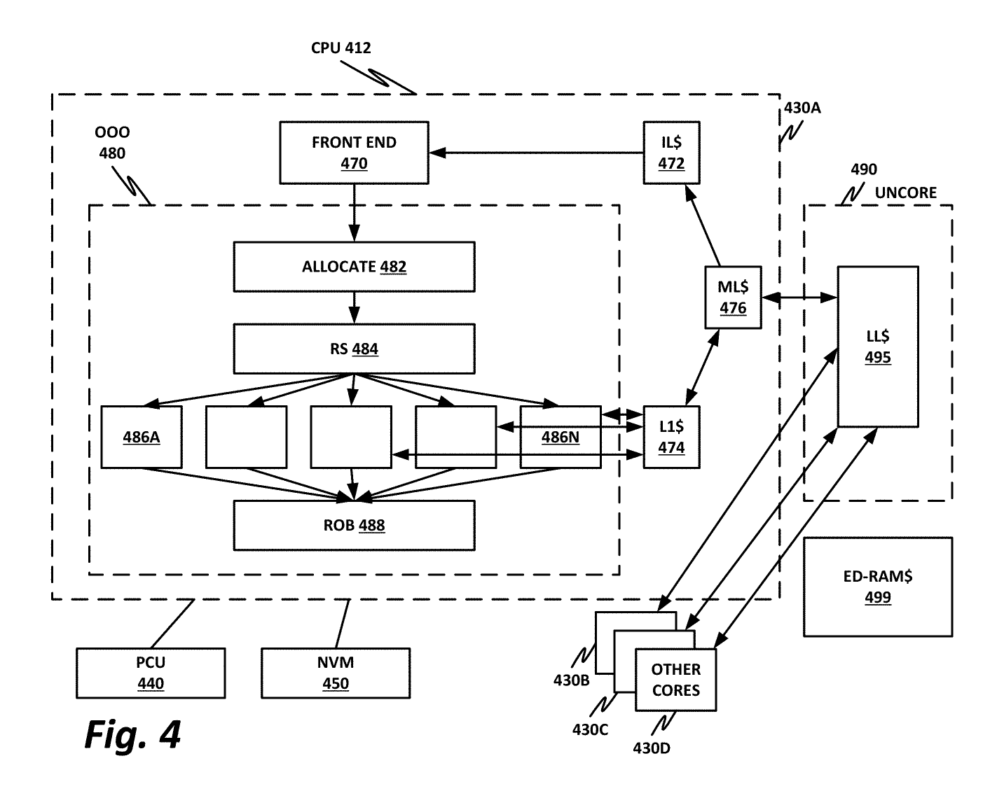

FIG. 4 illustrates a block diagram of a central processing unit (CPU) 412, according to one or more examples of the present specification. The disclosed architecture of FIG. 4 may be provided in some embodiments with the dynamic prefetcher tuning of the present specification, and may benefit therefrom. Although CPU 412 depicts a particular configuration, the cores and other components of CPU 412 may be arranged in any suitable manner. CPU 412 may comprise any processor or processing device, such as a microprocessor, an embedded processor, a digital signal processor (DSP), a network processor, an application processor, a co-processor, a system on a chip (SOC), or other device to execute code. CPU 412, in the depicted embodiment, includes four processing elements (cores 430 in the depicted embodiment), which may include asymmetric processing elements or symmetric processing elements. However, CPU 412 may include any number of processing elements that may be symmetric or asymmetric.

Examples of hardware processing elements include: a thread unit, a thread slot, a thread, a process unit, a context, a context unit, a logical processor, a hardware thread, a core, and/or any other element, which is capable of holding a state for a processor, such as an execution state or architectural state. In other words, a processing element, in one embodiment, refers to any hardware capable of being independently associated with code, such as a software thread, operating system, application, or other code. A physical processor (or processor socket) typically refers to an integrated circuit, which potentially includes any number of other processing elements, such as cores or hardware threads.

A core may refer to logic located on an integrated circuit capable of maintaining an independent architectural state, wherein each independently maintained architectural state is associated with at least some dedicated execution resources. A hardware thread may refer to any logic located on an integrated circuit capable of maintaining an independent architectural state, wherein the independently maintained architectural states share access to execution resources. A physical CPU may include any suitable number of cores. In various embodiments, cores may include one or more out-of-order processor cores or one or more in-order processor cores. However, cores may be individually selected from any type of core, such as a native core, a software managed core, a core adapted to execute a native instruction set architecture (ISA), a core adapted to execute a translated ISA, a co-designed core, or other known core. In a heterogeneous core environment (i.e. asymmetric cores), some form of translation, such as binary translation, may be utilized to schedule or execute code on one or both cores.

In the embodiment depicted, core 430A includes an out-of-order processor that has a front end unit 470 used to fetch incoming instructions, perform various processing (e.g. caching, decoding, branch predicting, etc.) and passing instructions/operations along to an out-of-order (OOO) engine. The OOO engine performs further processing on decoded instructions.

A front end 470 may include a decode module coupled to fetch logic to decode fetched elements. Fetch logic, in one embodiment, includes individual sequencers associated with thread slots of cores 430. Usually a core 430 is associated with a first ISA, which defines/specifies instructions executable on core 430. Often machine code instructions that are part of the first ISA include a portion of the instruction (referred to as an opcode), which references/specifies an instruction or operation to be performed. The decode module may include circuitry that recognizes these instructions from their opcodes and passes the decoded instructions on in the pipeline for processing as defined by the first ISA. Decoders of cores 430, in one embodiment, recognize the same ISA (or a subset thereof). Alternatively, in a heterogeneous core environment, a decoder of one or more cores (e.g., core 430B) may recognize a second ISA (either a subset of the first ISA or a distinct ISA).

In the embodiment depicted, the out-of-order engine includes an allocate unit 482 to receive decoded instructions, which may be in the form of one or more micro-instructions or uops, from front end unit 470, and allocate them to appropriate resources such as registers and so forth. Next, the instructions are provided to a reservation station 484, which reserves resources and schedules them for execution on one of a plurality of execution units 486A-486N. Various types of execution units may be present, including, for example, arithmetic logic units (ALUs), load and store units, vector processing units (VPUs), floating point execution units, among others. Results from these different execution units are provided to a reorder buffer (ROB) 488, which take unordered results and return them to correct program order.

In the embodiment depicted, both front end unit 470 and out-of-order engine 480 are coupled to different levels of a memory hierarchy. Specifically shown is an instruction level cache 472, that in turn couples to a mid-level cache 476, that in turn couples to a last level cache 495. In one embodiment, last level cache 495 is implemented in an on-chip (sometimes referred to as uncore) unit 490. Uncore 490 may communicate with system memory 499, which, in the illustrated embodiment, is implemented via embedded DRAM (eDRAM). The various execution units 486 within OOO engine 480 are in communication with a first level cache 474 that also is in communication with mid-level cache 476. Additional cores 430B-430D may couple to last level cache 495 as well.

In particular embodiments, uncore 490 may be in a voltage domain and/or a frequency domain that is separate from voltage domains and/or frequency domains of the cores. That is, uncore 490 may be powered by a supply voltage that is different from the supply voltages used to power the cores and/or may operate at a frequency that is different from the operating frequencies of the cores.

CPU 412 may also include a power control unit (PCU) 440. In various embodiments, PCU 440 may control the supply voltages and the operating frequencies applied to each of the cores (on a per-core basis) and to the uncore. PCU 440 may also instruct a core or uncore to enter an idle state (where no voltage and clock are supplied) when not performing a workload.

In various embodiments, PCU 440 may detect one or more stress characteristics of a hardware resource, such as the cores and the uncore. A stress characteristic may comprise an indication of an amount of stress that is being placed on the hardware resource. As examples, a stress characteristic may be a voltage or frequency applied to the hardware resource; a power level, current level, or voltage level sensed at the hardware resource; a temperature sensed at the hardware resource; or other suitable measurement. In various embodiments, multiple measurements (e.g., at different locations) of a particular stress characteristic may be performed when sensing the stress characteristic at a particular instance of time. In various embodiments, PCU 440 may detect stress characteristics at any suitable interval.

In various embodiments, PCU 440 is a component that is discrete from the cores 430. In particular embodiments, PCU 440 runs at a clock frequency that is different from the clock frequencies used by cores 430. In some embodiments where the PCU is a microcontroller, PCU 440 executes instructions according to an ISA that is different from an ISA used by cores 430.

In various embodiments, CPU 412 may also include a nonvolatile memory 450 to store stress information (such as stress characteristics, incremental stress values, accumulated stress values, stress accumulation rates, or other stress information) associated with cores 430 or uncore 490, such that when power is lost, the stress information is maintained.

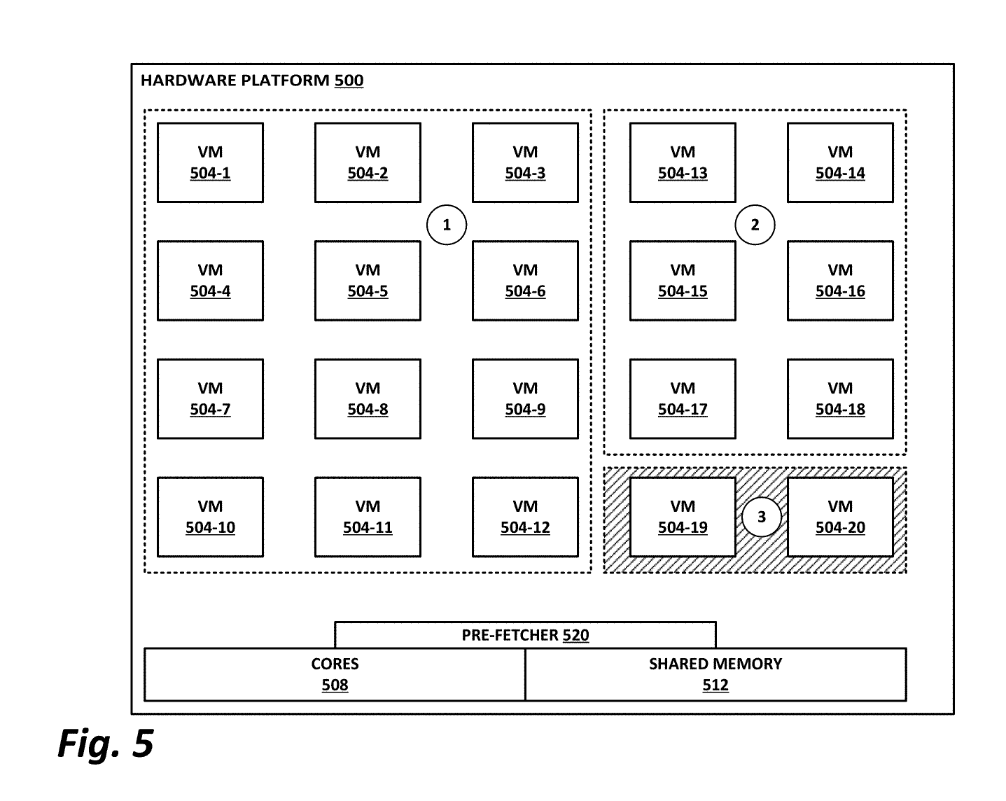

FIG. 5 is a block diagram of a hardware platform 500, according to one or more examples of the present specification. By way of illustration, hardware platform 500 may be a rackmount server in a large data center operated by a CSP. Hardware platform 500 includes a number of cores 508, along with a shared local memory 512. A prefetcher 520 is provided that performs hardware prefetching according to known methods.

In this example, hardware platform 500 includes a number of virtual machines 504-1 through 504-20, operated by several different tenants. For example, tenant 1 may operate VMs 504-1 through 504-12. These 12 VMs may provide a load balanced web server appliance, with some known architecture, such as one VM providing load balancing to the other 11, with the workload distributed across the 11 workload server appliances. As discussed above, the web server appliance provided by VMs 504-1 through 504-12 have relatively random accesses to memory, and thus receive less benefit from the use of prefetcher 520.

Tenant 2 may operate six VMs, namely VM 504-13 through VM 504-18. Similar to tenant 1, tenant 2 may operate a server appliance such as an e-mail appliance. As before, one VM may be allocated for load balancing or other services, while the other VMs may be provisioned as workload servers. These examples are provided by way of nonlimiting illustration only, and it should be understood that any appropriate allocation of workloads is possible.

As with tenant 1, tenant 2 operating an e-mail server appliance has relatively random memory accesses, and thus receives relatively little benefit from prefetcher 520. Note that this is not to say that prefetcher 520 provides no benefit to tenants 1 and 2, but rather that the benefit derived therefrom is relatively small because of the somewhat random nature of the memory access.

Tenant 3 is a “noisy neighbor” operating two VMs, namely VM 504-19 and VM 504-20. VMs 504-19 and 504-20 may be allocated a compute intensive task, such as protein folding or ray tracing. While it may seem unusual to provide such HPC operations within a cloud data center, it is actually quite possible to have such a situation with the popularity of massively distributed workloads, such as the Search for Extra-Terrestrial Intelligence Institute's SETI@home application or Stanford University's Folding@home distributed protein folding project.

The workload of tenant 3 may have a highly structured and relatively sequential memory access. Thus, tenant 3 may benefit substantially from prefetcher 520. Indeed, because tenant 3 has such a highly optimized and regular memory pattern, it may in fact substantially overwhelm the shared memory bus between VMs 504 and shared memory 512. Thus, tenants 1 and 2 may see a substantial performance hit while tenant 3 floods the shared memory bus with memory access operations. However, if hardware platform 500 is provided with the dynamic prefetcher tuning system of the present specification, then when tenant 3 begins to overwhelm the shared memory bus, prefetcher 520 can be turned off, so that tenants 1 and 2 may have more “fair” access to the shared memory resources. This helps to ensure that a noisy neighbor does not overwhelm the shared memory bus.

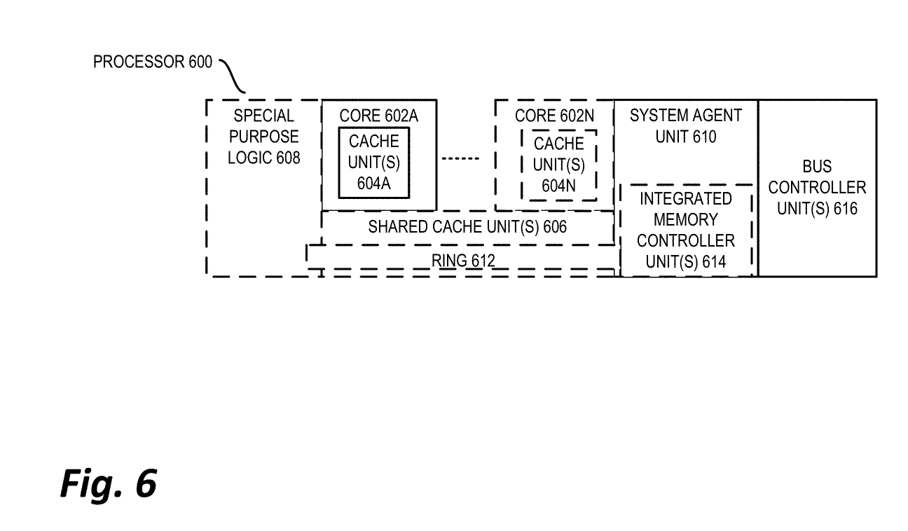

FIG. 6 is a block diagram of a processor 600 that may have more than one core, may have an integrated memory controller, and may have integrated graphics, according to one or more examples of the present specification. The disclosed architecture of FIG. 6 may be provided in some embodiments with a dynamic prefetcher tuning system within the hardware prefetcher of the memory controller 614 of FIG. 6, to provide the benefits described herein. The solid lined boxes in FIG. 6 illustrate a processor 600 with a single core 602A, a system agent 610, a set of one or more bus controller units 616, while the optional addition of the dashed lined boxes illustrates an alternative processor 600 with multiple cores 602A-N, a set of one or more integrated memory controller unit(s) 614 in the system agent unit 610, and special purpose logic 608.

Thus, different implementations of the processor 600 may include: 1) a CPU with the special purpose logic 608 being integrated graphics and/or scientific (throughput) logic (which may include one or more cores), and the cores 602A-N being one or more general purpose cores (e.g., general purpose in-order cores, general purpose out-of-order cores, a combination of the two); 2) a coprocessor with the cores 602A-N being a large number of special purpose cores intended primarily for graphics and/or scientific throughput; and 3) a coprocessor with the cores 602A-N being a large number of general purpose in-order cores. Thus, the processor 600 may be a general-purpose processor, coprocessor or special-purpose processor, such as, for example, a network or communication processor, compression engine, graphics processor, GPGPU (general purpose graphics processing unit), a high-throughput many integrated core (MIC) coprocessor (including 30 or more cores), embedded processor, or the like. The processor may be implemented on one or more chips. The processor 600 may be a part of and/or may be implemented on one or more substrates using any of a number of process technologies, such as, for example, BiCMOS, CMOS, or NMOS.

The memory hierarchy includes one or more levels of cache within the cores, a set or one or more shared cache units 606, and external memory (not shown) coupled to the set of integrated memory controller units 614. The set of shared cache units 606 may include one or more mid-level caches, such as level 2 (L2), level 3 (L3), level 4 (L4), or other levels of cache, a last level cache (LLC), and/or combinations thereof. While in one embodiment a ring based interconnect unit 612 interconnects the integrated graphics logic 608, the set of shared cache units 606, and the system agent unit 610/integrated memory controller unit(s) 614, alternative embodiments may use any number of well-known techniques for interconnecting such units. In one embodiment, coherency is maintained between one or more cache units 606 and cores 602A-N.

In some embodiments, one or more of the cores 602A-N are capable of multi-threading. The system agent 610 includes those components coordinating and operating cores 602A-N. The system agent unit 610 may include, for example, a power control unit (PCU) and a display unit. The PCU may be or include logic and components needed for regulating the power state of the cores 602A-N and the integrated graphics logic 608. The display unit is for driving one or more externally connected displays.

The cores 602A-N may be homogenous or heterogeneous in terms of architecture instruction set; that is, two or more of the cores 602A-N may be capable of executing the same instruction set, while others may be capable of executing only a subset of that instruction set or a different instruction set.

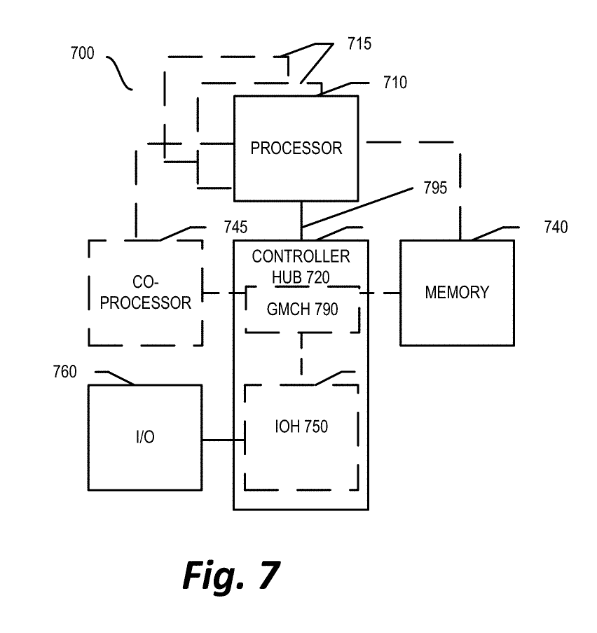

FIG. 7 is a block diagram of a system 700, according to one or more examples of the present specification. The disclosed architecture of FIG. 7 may be provided in some embodiments with a dynamic prefetcher tuning system within the hardware prefetcher of the memory controller 614 of FIG. 6, to provide the benefits described herein. The system 700 may include one or more processors 710, 715, which are coupled to a controller hub 720. In one embodiment the controller hub 720 includes a graphics memory controller hub (GMCH) 790 and an Input/Output Hub (IOH) 750 (which may be on separate chips); the GMCH 790 includes memory and graphics controllers to which are coupled memory 740 and a coprocessor 745; the IOH 750 couples input/output (IO) devices 760 to the GMCH 790. Alternatively, one or both of the memory and graphics controllers are integrated within the processor (as described herein), the memory 740 and the coprocessor 745 are coupled directly to the processor 710, and the controller hub 720 in a single chip with the IOH 750.

The optional nature of additional processors 715 is denoted in FIG. 7 with broken lines. Each processor 710, 715 may include one or more of the processing cores described herein.

The memory 740 may be, for example, dynamic random access memory (DRAM), phase change memory (PCM), or a combination of the two. For at least one embodiment, the controller hub 720 communicates with the processor(s) 710, 715 via a multidrop bus, such as a frontside bus (FSB), point-to-point interface such as Ultra Path Interconnect (UPI), or similar connection 795.

In one embodiment, the coprocessor 745 is a special-purpose processor, such as, for example, a high-throughput MIC processor, a network or communication processor, compression engine, graphics processor, GPGPU, embedded processor, or the like. In one embodiment, controller hub 720 may include an integrated graphics accelerator.

There can be a variety of differences between the physical resources 710, 715 in terms of a spectrum of metrics of merit including architectural, microarchitectural, thermal, power consumption characteristics, and the like.

In one embodiment, the processor 710 executes instructions that control data processing operations of a general type. Embedded within the instructions may be coprocessor instructions. The processor 710 recognizes these coprocessor instructions as being of a type that should be executed by the attached coprocessor 745. Accordingly, the processor 710 issues these coprocessor instructions (or control signals representing coprocessor instructions) on a coprocessor bus or other interconnect, to coprocessor 745. Coprocessor(s) 745 accepts and executes the received coprocessor instructions.

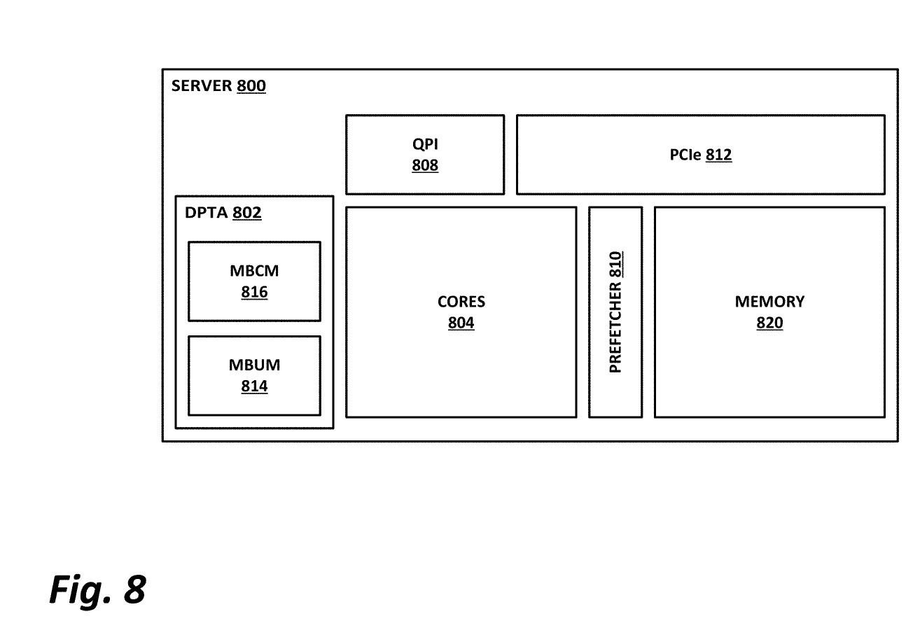

FIG. 8 is a block diagram of a server device 800, according to one or more examples of the present specification.

Embodiments of the present specification introduce a dynamic prefetcher tuning agent (DPTA) 802 to provide dynamic prefetcher tuning according to the description of the present specification. In certain embodiments, DPTA 802 may be provided as a firmware agent that periodically wakes to check memory bandwidth consumption and adjust prefetcher state accordingly. The use of DPTA 802 may be exposed to administrators through a BIOS option for enabling the feature and adjusting memory bandwidth thresholds for disabling and/or restoring the prefetcher state. These thresholds may be exposed to operators as a percentage of maximum theoretical bandwidth. An example would be disabling prefetchers as memory bandwidth climbs above 80% of maximum and restoring prefetcher state as bandwidth falls below 70% of maximum.

In this example, a number of cores 804 include a prefetcher 810, which as illustrated in FIG. 6 may be part of a hardware memory controller 614. Prefetcher 810 pre-fetches data from memory 820. Server 800 may also have various common buses such as an Intel Quick-Path™ interconnect bus 808, and/or a peripheral component interconnect express (PCIe) bus 812. For purposes of illustrating and clarifying the teachings of the present specification, server 800 has been substantially simplified, with the relevant portion shown. However, other embodiments of a server 800 may include many other systems and subsystems as well known in the art.

In this example, DPTA 802 includes two modules. A memory bandwidth computation module 816 may be provided to compute a theoretical maximum memory bandwidth capability at an appropriate time, such as at boot time, when a workload is changed, or at another appropriate time. A memory bandwidth utilization module 814 may be provided to periodically wake and measure memory bandwidth utilization. If the memory bandwidth utilization is above a first threshold, MBUM 814 can turn off prefetcher 810, thus throttling memory accesses by a noisy neighbor. Once prefetcher 810 is off, MBUM 814 may continue to wake and observe whether memory bandwidth utilization has fallen below a certain percentage. Once the memory bandwidth utilization falls below a second threshold, MBUM 814 may re-enable prefetcher 810.

Note that DPTA 802 is illustrated here as a single unit. However, MBCM 816 and MBUM 814 need not be provided on common hardware or as a common block. In various examples, DPTA 802, including MBCM 816 and/or MBUM 814 could be provided as a firmware module, a software module, a coprocessor, an FPGA, an ASIC, an intellectual property (IP) block, or any other suitable hardware, firmware, and/or software module, or combination thereof.

Embodiments of the present specification provide two new dedicated PMUs within the memory controller as fixed counters. These include UNC_M_CAS_COUNT.RD and UNC_M_CAS_COUNT.WR to measure memory bandwidth consumption from DPTA 802. It should be noted that UNC_M_CAS_COUNT.RD and UNC_M_CAS_COUNT.WR are names based on one possible architecture embodiment, and are nonlimiting. Different names may be employed for other embodiments as necessary. Embodiments also provide two new package-level CSRs. These are:

| CSR Name | Bits | Values |
|---|---|---|
| BANDWIDTH_PREFETCH_THRESHOLDS | 16 | 8 high bits define prefetcher threshold in |
| | | GB/sec, above which prefetchers are disabled. |
| | | 8 low bits define minimum threshold, below |
| | | which prefetcher state is restored. |
| DISABLE_PREFETCH | 1 | When set, the values set to |
| | | MISC_FEATURE_CONTROL (0x1A4) |
| | | are ignored, and all prefetch activity is |
| | | disabled. This bit is set when memory |
| | | bandwidth exceeds the maximum threshold |
| | | defined in |
| | | BANDWIDTH_PREFETCH_THRESHOLDS, |
| | | and cleared when bandwidth falls below the |
| | | minimum threshold. |

DPTA 802 may set bandwidth prefetch threshold CSR at boot time. Bandwidth prefetch threshold CSR may be calculated based on memory (e.g., frequency, channel population, and interleaving), and uncore frequency. During run time, DPTA 802 may check current bandwidth utilization, compare this value against the thresholds defined at boot, and disable or restore the prefetcher state accordingly.

In other words, at boot time, MBCM 816 establishes a threshold for maximum and memory bandwidth for prefetching. If the administrator has set raw bandwidth values for the threshold, those may be used. Otherwise, the threshold may be set as percentages of the calculated maximum theoretical memory bandwidth based on uncore frequency, memory frequency, channel population, and/or interleaving. A pre-populated table based on the microarchitecture for maximum bandwidth lookup may be used to simplify.

At run time, MBUM 814 wakes periodically, such as every N milliseconds. MBUM 814 measures the bandwidth using fixed memory controller PMUs. It checks the bandwidth against the thresholds set at boot time by MBCM 816, which may be stored in the new package-level CSRs. If the current bandwidth utilization is greater than the threshold set for disabling the prefetcher, then the value of DISABLE_PREFETCH is set to 0x1, disabling prefetchers and causing the value of 0x1A4 to be ignored. If DISABLE_PREFETCH already has a value of 0x1, and the current bandwidth is less than the second threshold set, then DISABLE_PREFETCH is set to 0x0 and the prefetcher state is restored (e.g., the value of register 0x1A4 is once again honored).

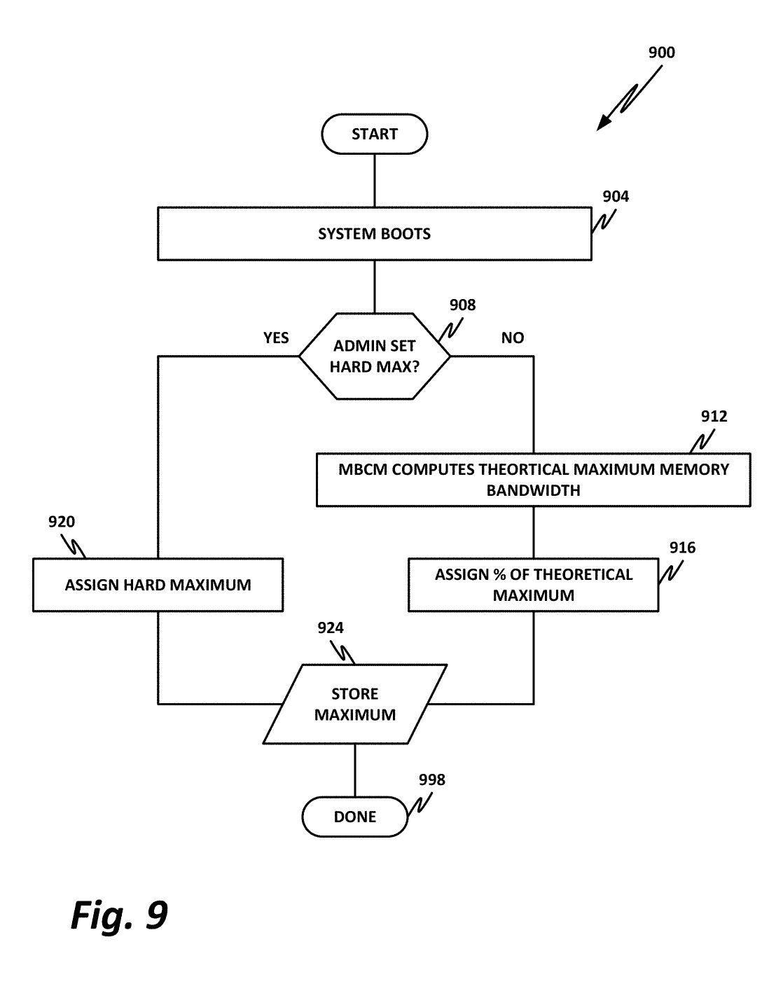

FIG. 9 is a block diagram of a method 900 performed, for example, at boot time to set prefetcher thresholds, according to one or more examples of the present specification.

Note that while in this example, method 900 is performed at boot time, it may be performed at any other appropriate time, such as when a workload changes, new VMs or workloads are established, or on other appropriate events.

In block 904, the system boots.

In decision block 908, the system (e.g., MBCM 816 of FIG. 8) checks whether the administrator has set a hard maximum prefetcher bandwidth utilization limit. For example, the administrator may set a hard maximum in terms of megabits per second.

If a hard bandwidth has been set, then in block 920, the system uses this hard maximum bandwidth as the threshold for disabling the prefetcher. Note that a hard threshold may also be set as a second threshold, which may be used for re-enabling the prefetcher once memory bandwidth utilization has dropped.

Returning to block 908, if a hard limit is not set, then in block 912, the MBCM, or other appropriate hardware or software, may compute the theoretical maximum memory bandwidth for the system as described above.

In block 916, the first threshold may then be assigned as a percentage of the theoretical maximum, which may be a value assigned by the administrator.

In block 924, the system stores the first threshold as either a hard maximum, or a percentage of the theoretical maximum. Note that in block 924, the system may also store the second threshold, which is a threshold for re-enabling the prefetcher after it has been disabled.

In block 998, the method is done.

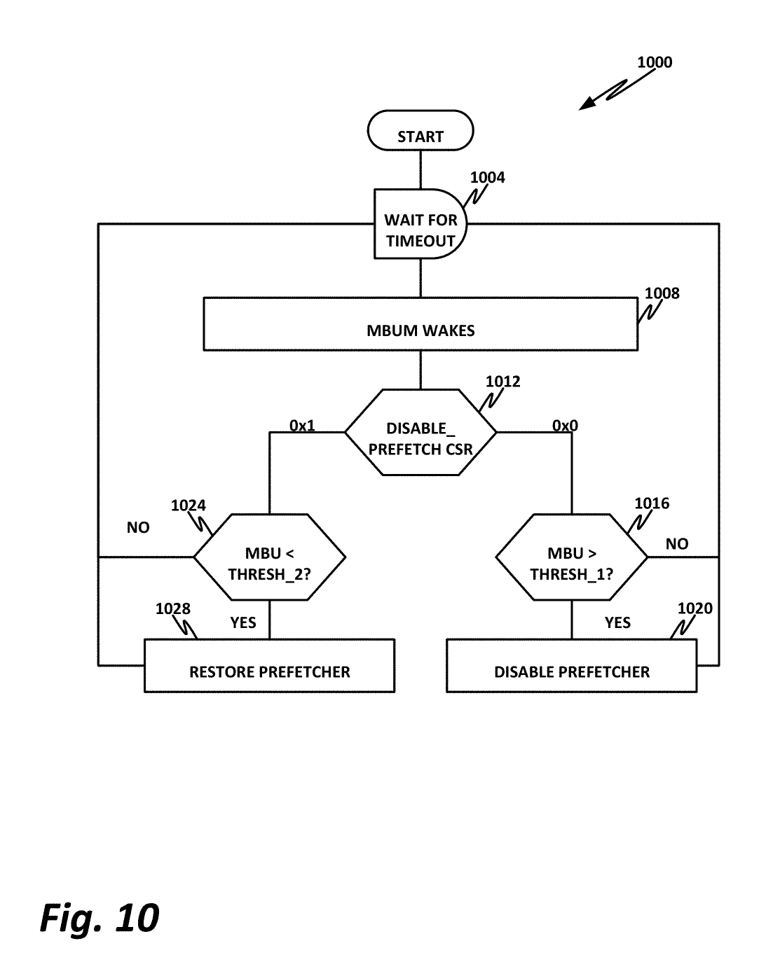

FIG. 10 is a flowchart of a method 1000, according to one or more examples of the present specification. In various embodiments, method 1000 may be performed by MBUM 814 of FIG. 8, or by any other appropriate hardware and/or software or firmware.

In block 1004, the system waits until a timeout is reached. For example, the system may awake every N milliseconds to perform its check.

In block 1008, MBUM awakes. Note that any other suitable hardware, software, and/or firmware may be substituted herein for the MBUM.

In decision block 1012, the MBUM determines whether the prefetcher is on.

If the prefetcher is on, then in decision block 1016, the MBUM checks whether the memory bandwidth utilization is greater than threshold 1. If the utilization is greater than threshold 1, then in block 1020, the prefetcher is disabled. Control then returns to block 1004 where the MBUM waits for the next timeout where it will wake up and again perform its function.

Returning to decision block 1012, if the prefetcher is not on, then in decision block 1024, the MBUM checks whether memory utilization has now fallen beneath threshold 2.

If memory utilization has fallen beneath threshold 2, then in block 1028, the prefetcher is re-enabled. If not, then there is no change. In either case, control returns back to block 1004, where the MBUM waits for the next timeout and awakes to perform its function.

The foregoing outlines features of one or more embodiments of the subject matter disclosed herein. These embodiments are provided to enable a person having ordinary skill in the art (PHOSITA) to better understand various aspects of the present disclosure. Certain well-understood terms, as well as underlying technologies and/or standards may be referenced without being described in detail. It is anticipated that the PHOSITA will possess or have access to background knowledge or information in those technologies and standards sufficient to practice the teachings of the present specification.

The PHOSITA will appreciate that they may readily use the present disclosure as a basis for designing or modifying other processes, structures, or variations for carrying out the same purposes and/or achieving the same advantages of the embodiments introduced herein. The PHOSITA will also recognize that such equivalent constructions do not depart from the spirit and scope of the present disclosure, and that they may make various changes, substitutions, and alterations herein without departing from the spirit and scope of the present disclosure.

In the foregoing description, certain aspects of some or all embodiments are described in greater detail than is strictly necessary for practicing the appended claims. These details are provided by way of non-limiting example only, for the purpose of providing context and illustration of the disclosed embodiments. Such details should not be understood to be required, and should not be “read into” the claims as limitations. The phrase may refer to “an embodiment” or “embodiments.” These phrases, and any other references to embodiments, should be understood broadly to refer to any combination of one or more embodiments. Furthermore, the several features disclosed in a particular “embodiment” could just as well be spread across multiple embodiments. For example, if features 1 and 2 are disclosed in “an embodiment,” embodiment A may have feature 1 but lack feature 2, while embodiment B may have feature 2 but lack feature 1.

This specification may provide illustrations in a block diagram format, wherein certain features are disclosed in separate blocks. These should be understood broadly to disclose how various features interoperate, but are not intended to imply that those features must necessarily be embodied in separate hardware or software. Furthermore, where a single block discloses more than one feature in the same block, those features need not necessarily be embodied in the same hardware and/or software. For example, a computer “memory” could in some circumstances be distributed or mapped between multiple levels of cache or local memory, main memory, battery-backed volatile memory, and various forms of persistent memory such as a hard disk, storage server, optical disk, tape drive, or similar. In certain embodiments, some of the components may be omitted or consolidated. In a general sense, the arrangements depicted in the figures may be more logical in their representations, whereas a physical architecture may include various permutations, combinations, and/or hybrids of these elements. Countless possible design configurations can be used to achieve the operational objectives outlined herein. Accordingly, the associated infrastructure has a myriad of substitute arrangements, design choices, device possibilities, hardware configurations, software implementations, and equipment options.

References may be made herein to a computer-readable medium, which may be a tangible and non-transitory computer-readable medium. As used in this specification and throughout the claims, a “computer-readable medium” should be understood to include one or more computer-readable mediums of the same or different types. A computer-readable medium may include, by way of non-limiting example, an optical drive (e.g., CD/DVD/Blu-Ray), a hard drive, a solid-state drive, a flash memory, or other non-volatile medium. A computer-readable medium could also include a medium such as a read-only memory (ROM), an FPGA or ASIC configured to carry out the desired instructions, stored instructions for programming an FPGA or ASIC to carry out the desired instructions, an intellectual property (IP) block that can be integrated in hardware into other circuits, or instructions encoded directly into hardware or microcode on a processor such as a microprocessor, digital signal processor (DSP), microcontroller, or in any other suitable component, device, element, or object where appropriate and based on particular needs. A nontransitory storage medium herein is expressly intended to include any nontransitory special-purpose or programmable hardware configured to provide the disclosed operations, or to cause a processor to perform the disclosed operations.

Various elements may be “communicatively,” “electrically,” “mechanically,” or otherwise “coupled” to one another throughout this specification and the claims. Such coupling may be a direct, point-to-point coupling, or may include intermediary devices. For example, two devices may be communicatively coupled to one another via a controller that facilitates the communication. Devices may be electrically coupled to one another via intermediary devices such as signal boosters, voltage dividers, or buffers. Mechanically-coupled devices may be indirectly mechanically coupled.

Any “module” or “engine” disclosed herein may refer to or include software, a software stack, a combination of hardware, firmware, and/or software, a circuit configured to carry out the function of the engine or module, or any computer-readable medium as disclosed above. Such modules or engines may, in appropriate circumstances, be provided on or in conjunction with a hardware platform, which may include hardware compute resources such as a processor, memory, storage, interconnects, networks and network interfaces, accelerators, or other suitable hardware. Such a hardware platform may be provided as a single monolithic device (e.g., in a PC form factor), or with some or part of the function being distributed (e.g., a “composite node” in a high-end data center, where compute, memory, storage, and other resources may be dynamically allocated and need not be local to one another).

There may be disclosed herein flow charts, signal flow diagram, or other illustrations showing operations being performed in a particular order. Unless otherwise expressly noted, or unless required in a particular context, the order should be understood to be a non-limiting example only. Furthermore, in cases where one operation is shown to follow another, other intervening operations may also occur, which may be related or unrelated. Some operations may also be performed simultaneously or in parallel. In cases where an operation is said to be “based on” or “according to” another item or operation, this should be understood to imply that the operation is based at least partly on or according at least partly to the other item or operation. This should not be construed to imply that the operation is based solely or exclusively on, or solely or exclusively according to the item or operation.

All or part of any hardware element disclosed herein may readily be provided in a system-on-a-chip (SoC), including a central processing unit (CPU) package. An SoC represents an integrated circuit (IC) that integrates components of a computer or other electronic system into a single chip. Thus, for example, client devices or server devices may be provided, in whole or in part, in an SoC. The SoC may contain digital, analog, mixed-signal, and radio frequency functions, all of which may be provided on a single chip substrate. Other embodiments may include a multichip module (MCM), with a plurality of chips located within a single electronic package and configured to interact closely with each other through the electronic package.

In a general sense, any suitably-configured circuit or processor can execute any type of instructions associated with the data to achieve the operations detailed herein. Any processor disclosed herein could transform an element or an article (for example, data) from one state or thing to another state or thing. Furthermore, the information being tracked, sent, received, or stored in a processor could be provided in any database, register, table, cache, queue, control list, or storage structure, based on particular needs and implementations, all of which could be referenced in any suitable timeframe. Any of the memory or storage elements disclosed herein, should be construed as being encompassed within the broad terms “memory” and “storage,” as appropriate.

Computer program logic implementing all or part of the functionality described herein is embodied in various forms, including, but in no way limited to, a source code form, a computer executable form, machine instructions or microcode, programmable hardware, and various intermediate forms (for example, forms generated by an assembler, compiler, linker, or locator). In an example, source code includes a series of computer program instructions implemented in various programming languages, such as an object code, an assembly language, or a high-level language such as OpenCL, FORTRAN, C, C++, JAVA, or HTML for use with various operating systems or operating environments, or in hardware description languages such as Spice, Verilog, and VHDL. The source code may define and use various data structures and communication messages. The source code may be in a computer executable form (e.g., via an interpreter), or the source code may be converted (e.g., via a translator, assembler, or compiler) into a computer executable form, or converted to an intermediate form such as byte code. Where appropriate, any of the foregoing may be used to build or describe appropriate discrete or integrated circuits, whether sequential, combinatorial, state machines, or otherwise.

In one example embodiment, any number of electrical circuits of the FIGURES may be implemented on a board of an associated electronic device. The board can be a general circuit board that can hold various components of the internal electronic system of the electronic device and, further, provide connectors for other peripherals. Any suitable processor and memory can be suitably coupled to the board based on particular configuration needs, processing demands, and computing designs. Note that with the numerous examples provided herein, interaction may be described in terms of two, three, four, or more electrical components. However, this has been done for purposes of clarity and example only. It should be appreciated that the system can be consolidated or reconfigured in any suitable manner. Along similar design alternatives, any of the illustrated components, modules, and elements of the FIGURES may be combined in various possible configurations, all of which are within the broad scope of this specification.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 (pre-AIA) or paragraph (f) of the same section (post-AIA), as it exists on the date of the filing hereof unless the words “means for” or “steps for” are specifically used in the particular claims; and (b) does not intend, by any statement in the specification, to limit this disclosure in any way that is not otherwise expressly reflected in the appended claims.

### EXAMPLE IMPLEMENTATIONS

The following examples are provided by way of illustration.

Example 1 includes a server apparatus for use in a data center, comprising: a processor having a memory prefetcher; a memory; a memory bus to communicatively couple the processor to the memory; and a dynamic prefetcher tuning agent (DPTA) comprising a memory bandwidth utilization module (MBUM) configured to: determine that the prefetcher is enabled; determine that memory bandwidth utilization of the memory bus exceeds a first threshold; and disable the prefetcher.

Example 2 includes the server apparatus of example 1, wherein the first threshold is approximately 80% of a theoretical maximum bandwidth of the memory bus.

Example 3 includes the server apparatus of example 1, wherein the MBUM is further configured to: determine that the prefetcher is disabled; determine that memory bandwidth utilization is below a second threshold; and enable the prefetcher.

Example 4 includes the server apparatus of example 3, wherein the second threshold is approximately 70% of a theoretical maximum bandwidth of the memory bus.

Example 5 includes the server apparatus of example 1, wherein the DPTA further comprises a memory bandwidth computation module (MBCM) configured to compute a theoretical maximum memory bandwidth of the memory bus.

Example 6 includes the server apparatus of example 5, wherein computing the theoretical maximum memory bandwidth comprises receiving a property of the memory bus via a data source.

Example 7 includes the server apparatus of example 6, wherein the data source comprises one or more model-specific registers (MSRs).

Example 8 includes the server apparatus of example 6, wherein the property comprises a memory speed.

Example 9 includes the server apparatus of example 6, wherein the property comprises a memory channel population.

Example 10 includes the server apparatus of example 6, wherein the property comprises a channel interleaving setting.

Example 11 includes the server apparatus of example 6, wherein the property comprises an uncore frequency.

Example 12 includes the server apparatus of example 6, wherein the MBCM is configured to compute the theoretical maximum memory bandwidth at boot time.

Example 13 includes the server apparatus of example 6, wherein the MBCM is configured to compute the theoretical maximum memory bandwidth periodically.

Example 14 includes the server apparatus of example 6, wherein the MBCM is configured to compute the theoretical maximum memory in response to a stimulus.

Example 15 includes the server apparatus of any of examples 1-14, wherein the DPTA comprises a firmware module.

Example 16 includes the server apparatus of any of examples 1-14, wherein the DPTA comprises microcode.

Example 17 includes the server apparatus of any of examples 1-14, wherein the DPTA comprises hardware instructions.

Example 18 includes the server apparatus of any of examples 1-14, wherein the DPTA comprises a firmware module.

Example 19 includes the server apparatus of any of examples 1-14, wherein the DPTA comprises hardware instructions.

Example 20 includes the server apparatus of any of examples 1-14, wherein the DPTA comprises a coprocessor.

Example 21 includes the server apparatus of any of examples 1-14, wherein the DPTA comprises a field-programmable gate array.

Example 22 includes the server apparatus of any of examples 1-14, wherein the DPTA comprises an application-specific integrated circuit.

Example 23 includes the server apparatus of any of examples 1-14, wherein the DPTA comprises an intellectual property block.

Example 24 includes one or more tangible, non-transitory computer-readable storage mediums having stored thereon computer-operable instructions to: provide a dynamic prefetcher tuning agent (DPTA) comprising a memory bandwidth utilization module (MBUM) configured to: determine that a prefetcher of a processor is enabled; determine that memory bandwidth utilization of the memory bus exceeds a first threshold; and disable the prefetcher.

Example 25 includes the one or more tangible, computer-readable storage mediums of example 24, wherein the first threshold is approximately 80% of a theoretical maximum bandwidth of the memory bus.

Example 26 includes the one or more tangible, computer-readable storage mediums of example 24, wherein the MBUM is further configured to: determine that the prefetcher is disabled; determine that memory bandwidth utilization is below a second threshold; and enable the prefetcher.

Example 27 includes the one or more tangible, computer-readable storage mediums of example 26, wherein the second threshold is approximately 70% of a theoretical maximum bandwidth of the memory bus.

Example 28 includes the one or more tangible, computer-readable storage mediums of example 24, wherein the DPTA further comprises a memory bandwidth computation module (MBCM) configured to compute a theoretical maximum memory bandwidth of the memory bus.

Example 29 includes the one or more tangible, computer-readable storage mediums of example 28, wherein computing the theoretical maximum memory bandwidth comprises receiving a property of the memory bus via a data source.

Example 30 includes the one or more tangible, computer-readable storage mediums of example 29, wherein the data source comprises one or more model-specific registers (MSRs).

Example 31 includes the one or more tangible, computer-readable storage mediums of example 29, wherein the property comprises a memory speed.

Example 32 includes the one or more tangible, computer-readable storage mediums of example 29, wherein the property comprises a memory channel population.

Example 33 includes the one or more tangible, computer-readable storage mediums of example 29, wherein the property comprises a channel interleaving setting.

Example 34 includes the one or more tangible, computer-readable storage mediums of example 29, wherein the property comprises an uncore frequency.

Example 35 includes the one or more tangible, computer-readable storage mediums of example 29, wherein the MBCM is configured to compute the theoretical maximum memory bandwidth at boot time.

Example 36 includes the one or more tangible, computer-readable storage mediums of example 29, wherein the MBCM is configured to compute the theoretical maximum memory bandwidth periodically.

Example 37 includes the one or more tangible, computer-readable storage mediums of example 29, wherein the MBCM is configured to compute the theoretical maximum memory in response to a stimulus.

Example 38 includes the one or more tangible, computer-readable storage mediums of any of examples 24-38, wherein the one or more mediums comprise a firmware module.

Example 39 includes the one or more tangible, computer-readable storage mediums of any of examples 24-38, wherein the one or more mediums comprise microcode.

Example 40 includes the one or more tangible, computer-readable storage mediums of any of examples 24-38, wherein the one or more mediums comprise hardware instructions.

Example 41 includes the one or more tangible, computer-readable storage mediums of any of examples 24-38, wherein the one or more mediums comprise a firmware module.

Example 42 includes the one or more tangible, computer-readable storage mediums of any of examples 24-38, wherein the one or more mediums comprise a coprocessor.

Example 43 includes the one or more tangible, computer-readable storage mediums of any of examples 24-38, wherein the one or more mediums comprise a field-programmable gate array.

Example 44 includes the one or more tangible, computer-readable storage mediums of any of examples 24-38, wherein the one or more mediums comprise an application-specific integrated circuit.

Example 45 includes the one or more tangible, computer-readable storage mediums of any of examples 24-38, wherein the one or more mediums comprise an intellectual property block.

Example 46 includes computer-implemented method of providing dynamic tuning of a hardware prefetcher, comprising: determining that a prefetcher is enabled; determining that memory bandwidth utilization of a memory bus interconnecting a memory with a processor exceeds a first threshold; and disabling the prefetcher.

Example 47 includes the method of example 46, wherein the first threshold is approximately 80% of a theoretical maximum bandwidth of the memory bus.

Example 48 includes the method of example 46, further comprising: determining that the prefetcher is disabled; determining that memory bandwidth utilization is below a second threshold; and enabling the prefetcher.

Example 49 includes the method of example 48, wherein the second threshold is approximately 70% of a theoretical maximum bandwidth of the memory bus.

Example 50 includes the method of example 46, further comprising computing a theoretical maximum memory bandwidth of the memory bus.

Example 51 includes the method of example 50, wherein computing the theoretical maximum memory bandwidth comprises receiving a property of the memory bus via a data source.

Example 52 includes the method of example 51, wherein the data source comprises one or more model-specific registers (MSRs).

Example 53 includes the method of example 51, wherein the property comprises a memory speed.

Example 54 includes the method of example 51, wherein the property comprises a memory channel population.

Example 55 includes the method of example 51, wherein the property comprises a channel interleaving setting.

Example 56 includes the method of example 51, wherein the property comprises an uncore frequency.

Example 57 includes the method of example 51, further comprising computing the theoretical maximum memory bandwidth at boot time.

Example 58 includes the method of example 51, further comprising computing the theoretical maximum memory bandwidth periodically.

Example 59 includes the method of example 51, further comprising computing the theoretical maximum memory in response to a stimulus.

Example 60 includes an apparatus comprising means for performing the method of any of examples 46-59.

Example 61 includes the apparatus of example 60, wherein the means comprise a computing apparatus comprising a processor, a memory, and a memory bus to communicatively couple the processor to the memory.

Example 62 includes the apparatus of example 60, wherein the means comprise one or more tangible, non-transitory computer-readable storage mediums having stored thereon computer-operable instructions to perform the method.

Example 63 includes the one or more tangible, computer-readable storage mediums of example 62, wherein the one or more mediums comprise a firmware module.

Example 64 includes the one or more tangible, computer-readable storage mediums of example 62, wherein the one or more mediums comprise microcode.

Example 65 includes the one or more tangible, computer-readable storage mediums of example 62, wherein the one or more mediums comprise hardware instructions.

Example 66 includes the one or more tangible, computer-readable storage mediums of example 62, wherein the one or more mediums comprise a firmware module.

Example 67 includes the one or more tangible, computer-readable storage mediums of example 62, wherein the one or more mediums comprise a coprocessor.

Example 68 includes the one or more tangible, computer-readable storage mediums of example 62, wherein the one or more mediums comprise a field-programmable gate array.

Example 69 includes the one or more tangible, computer-readable storage mediums of example 62, wherein the one or more mediums comprise an application-specific integrated circuit.

Example 70 includes the one or more tangible, computer-readable storage mediums of example 62, wherein the one or more mediums comprise an intellectual property block.

1. A server apparatus for use in a data center, comprising:
a processor having a memory prefetcher;
a memory;
a memory bus to communicatively couple the processor to the memory; and
a dynamic prefetcher tuning agent (DPTA) comprising a memory bandwidth utilization module (MBUM) configured to:
determine that the prefetcher is enabled;
determine that memory bandwidth utilization of the memory bus exceeds a first threshold; and
disable the prefetcher.

2. The server apparatus of claim 1, wherein the first threshold is approximately 80% of a theoretical maximum bandwidth of the memory bus.

3. The server apparatus of claim 1, wherein the MBUM is further configured to:
determine that the prefetcher is disabled;
determine that memory bandwidth utilization is below a second threshold; and
enable the prefetcher.

4. The server apparatus of claim 3, wherein the second threshold is approximately 70% of a theoretical maximum bandwidth of the memory bus.

5. The server apparatus of claim 1, wherein the DPTA further comprises a memory bandwidth computation module (MBCM) configured to compute a theoretical maximum memory bandwidth of the memory bus.

6. The server apparatus of claim 5, wherein computing the theoretical maximum memory bandwidth comprises receiving a property of the memory bus via a data source.

7. The server apparatus of claim 6, wherein the data source comprises one or more model-specific registers (MSRs).

8. The server apparatus of claim 6, wherein the property comprises a memory speed.

9. The server apparatus of claim 6, wherein the property comprises a memory channel population.

10. The server apparatus of claim 6, wherein the property comprises a channel interleaving setting.

11. The server apparatus of claim 6, wherein the property comprises an uncore frequency.

12. The server apparatus of claim 6, wherein the MBCM is configured to compute the theoretical maximum memory bandwidth at boot time.

13. The server apparatus of claim 6, wherein the MBCM is configured to compute the theoretical maximum memory bandwidth periodically.

14. The server apparatus of claim 6, wherein the MBCM is configured to compute the theoretical maximum memory in response to a stimulus.

15. The server apparatus of claim 1, wherein the DPTA comprises an agent selected from the group consisting of a firmware module, microcode, hardware instructions, a coprocessor, a field-programmable gate array, an application-specific integrated circuit, and an intellectual property block.

16. One or more tangible, non-transitory computer-readable storage mediums having stored thereon computer-operable instructions to:
provide a dynamic prefetcher tuning agent (DPTA) comprising a memory bandwidth utilization module (MBUM) configured to:
determine that a prefetcher of a processor is enabled;
determine that memory bandwidth utilization of a memory bus exceeds a first threshold; and
disable the prefetcher.

17. The one or more tangible, computer-readable storage mediums of claim 16, wherein the first threshold is approximately 80% of a theoretical maximum bandwidth of the memory bus.

18. The one or more tangible, computer-readable storage mediums of claim 16, wherein the MBUM is further configured to:
determine that the prefetcher is disabled;
determine that memory bandwidth utilization is below a second threshold; and
enable the prefetcher.

19. The one or more tangible, computer-readable storage mediums of claim 18, wherein the second threshold is approximately 70% of a theoretical maximum bandwidth of the memory bus.

20. The one or more tangible, computer-readable storage mediums of claim 16, wherein the DPTA further comprises a memory bandwidth computation module (MBCM) configured to compute a theoretical maximum memory bandwidth of the memory bus.

21. The one or more tangible, computer-readable storage mediums of claim 20, wherein computing the theoretical maximum memory bandwidth comprises receiving a property of the memory bus via a data source.

22. The one or more tangible, computer-readable storage mediums of claim 21, wherein the data source comprises one or more model-specific registers (MSRs).

23. The one or more tangible, computer-readable storage mediums of claim 21, wherein the property is selected from the group consisting of a memory speed, a memory channel population, a channel interleaving setting, and an uncore frequency.

24. A computer-implemented method of providing dynamic tuning of a hardware prefetcher, comprising:
determining that a prefetcher is enabled;
determining that memory bandwidth utilization of a memory bus interconnecting a memory with a processor exceeds a first threshold; and
disabling the prefetcher.

25. The method of claim 24, further comprising:
determining that the prefetcher is disabled;
determining that memory bandwidth utilization is below a second threshold; and
enabling the prefetcher.

26. The method of claim 24, further comprising computing a theoretical maximum memory bandwidth of the memory bus.
